(19) United States
(12) Patent Application Publication
(10) Pub. No.: US 2024/0038437 A1
(43) Pub. Date: Feb. 1, 2024

(54) Planar Transformer and Related Device

(71) Applicant: Huawei Digital Power Technologies Co., Ltd., Shenzhen (CN)

(72) Inventors: Peng Yu, Dongguan (CN); Jun Zou, Shenzhen (CN)

(21) Appl. No.: 18/486,469

(22) Filed: Oct. 13, 2023

Related U.S. Application Data
(63) Continuation of application No. PCT/CN2021/087201, filed on Apr. 14, 2021.

(51) Int. Cl. H01F 27/28; H01F 27/24; H01F 27/30

(52) U.S. Cl. CPC H01F 27/2804; H01F 27/24; H01F 27/306

(57) ABSTRACT

A planar transformer includes a magnetic core. The magnetic core includes a first magnetic core cover, a second magnetic core cover, n first magnetic core pillars, and k second magnetic core pillars, the n first magnetic core pillars and the k second magnetic core pillars are disposed between the first magnetic core cover and the second magnetic core cover, and n and k each are an integer greater than 0. A primary-side winding and a secondary-side winding that are coupled to each other are disposed on each of the n first magnetic core pillars, and an auxiliary inductor winding is disposed on each of the k second magnetic core pillars.

### CROSS-REFERENCE TO RELATED APPLICATIONS

This is a continuation of International Patent Application No. PCT/CN2021/087201 filed on Apr. 14, 2021, the disclosure of which is hereby incorporated by reference in its entirety.

### TECHNICAL FIELD

The present disclosure relates to the field of power electronics technologies, and in particular, to a planar transformer and a related device.

### BACKGROUND

A planar transformer is a transformer having features such as a high frequency, a low profile, a low height, and a high operating frequency. A transformer is a key component in a power supply. A conventional transformer usually includes a ferrite magnetic core and a copper coil, has a large volume, and easily generates electromagnetic interference. The planar transformer may effectively resolve problems of a volume and a high frequency, and may be widely applied to electronic devices in various fields.

However, as power supplies of devices such as various terminal products and electronic medium screens continuously evolve toward miniaturization and ultra-thinness, thinness of an existing planar transformer still cannot meet a requirement. Therefore, how to design a thinner planar transformer is an urgent technical problem that needs to be resolved by persons skilled in the art.

### SUMMARY

This application discloses a planar transformer and a related device. The planar transformer becomes thinner, and can better satisfy a design of an ultra-thin product.

According to a first aspect, this application provides a planar transformer, including a magnetic core, where the magnetic core includes a first magnetic core cover, a second magnetic core cover, n first magnetic core pillars, and k second magnetic core pillars, the n first magnetic core pillars and the k second magnetic core pillars are disposed between the first magnetic core cover and the second magnetic core cover, and n and k each are an integer greater than 0; and a primary-side winding and a secondary-side winding that are coupled to each other are disposed on each of the n first magnetic core pillars, and an auxiliary inductor winding is disposed on each of the k second magnetic core pillars; and when power is supplied, a first magnetic flux cancels a part of a second magnetic flux when passing through the first magnetic core cover and the second magnetic core cover, the first magnetic flux is a magnetic flux generated by auxiliary inductor windings disposed on the k second magnetic core pillars, and the second magnetic flux is a magnetic flux generated by primary-side windings disposed on the n first magnetic core pillars.

In this application, the auxiliary inductor winding is added to generate a magnetic flux, so that the magnetic flux can partially cancel, on the magnetic core cover, the magnetic flux of the primary-side winding of the transformer, to reduce magnetic fluxes passing through the magnetic core cover. In this way, a thinner magnetic core cover can be designed, to better satisfy a design of an ultra-thin product.

In addition, compared with an existing technical solution, in this application, in a design of a planar transformer that outputs a small current, the magnetic fluxes passing through the magnetic core cover may also be reduced, so that the thinner magnetic core cover can be designed, to better satisfy the design of the ultra-thin product. The planar transformer that outputs a small current may be, for example, a planar transformer including only one or two pairs of transformer windings (one pair of transformer windings includes one primary-side winding of the transformer and one secondary-side winding of the transformer).

In a possible implementation, a structure of the first magnetic core cover is symmetrical to a structure of the second magnetic core cover, the first magnetic core cover includes a first primary magnetic core cover and a first auxiliary magnetic core cover, the second magnetic core cover includes a second primary magnetic core cover and a second auxiliary magnetic core cover, and an area of the first auxiliary magnetic core cover is less than an area of the first primary magnetic core cover in a top view obtained by viewing the planar transformer in a direction from the first magnetic core cover to the second magnetic core cover; and that the n first magnetic core pillars and the k second magnetic core pillars are disposed between the first magnetic core cover and the second magnetic core cover includes: the n first magnetic core pillars are disposed between the first primary magnetic core cover and the second primary magnetic core cover and are perpendicularly connected to the first primary magnetic core cover and the second primary magnetic core cover; and the k second magnetic core pillars are disposed between the first auxiliary magnetic core cover and the second auxiliary magnetic core cover and are perpendicularly connected to the first auxiliary magnetic core cover and the second auxiliary magnetic core cover.

In this application, an area of an auxiliary magnetic core cover is designed to be less than an area of a primary magnetic core cover, so that an area occupied by the entire magnetic core can be reduced. Compared with an existing technical solution, in this application, an increase is small although the area occupied by the entire magnetic core is increased by the area of the auxiliary magnetic core cover. In other words, in this application, the thinner magnetic core cover can be designed only at low costs of the area occupied by the magnetic core, to better meet design requirements of an ultra-thin product.

In a possible implementation, a cross-sectional area of the second magnetic core pillar is less than a cross-sectional area of the first magnetic core pillar.

In this application, an area occupied by the magnetic core cover can be correspondingly reduced by reducing the cross-sectional area of the second magnetic core pillar, to reduce the area occupied by the entire magnetic core.

In a possible implementation, a cross-sectional area ratio of the first magnetic core pillar to the second magnetic core pillar is equal to a ratio of a quantity of turns of the auxiliary inductor winding of the second magnetic core pillar to a quantity of turns of the primary-side winding of the first magnetic core pillar.

In this application, if magnetic flux densities existing when the magnetic flux generated by the auxiliary inductor winding and the magnetic flux generated by the primary-side winding of the transformer are transmitted in the magnetic core pillar are the same, a turn ratio of the auxiliary inductor winding to the primary-side winding of the transformer is equal to a cross-sectional area ratio of the primary-side winding of the transformer to the auxiliary inductor winding. In other words, the turn ratio of the auxiliary inductor winding to the primary-side winding of the transformer is equal to a cross-sectional area ratio of the first magnetic core pillar to the second magnetic core pillar. In other words, based on the design in this application, the magnetic flux can be transmitted evenly, so that the secondary-side winding better generates magnetic induction, and a loss of the magnetic core is reduced. In addition, in this application, the cross-sectional area ratio of the first magnetic core pillar to the second magnetic core pillar may be further controlled by controlling the turn ratio of the auxiliary inductor winding to the primary-side winding of the transformer.

In a possible implementation, the quantity of turns of the auxiliary inductor winding is greater than the quantity of turns of the primary-side winding.

Because an inductance value is directly proportional to a square of a quantity of turns, and a larger inductance value indicates a smaller current of an inductor and leads to a smaller generated additional winding loss, based on the design in this application, a loss of the auxiliary inductor winding can be reduced.

In a possible implementation, the auxiliary inductor winding and the primary-side winding are electrically connected.

In a possible implementation, n primary-side windings of the n first magnetic core pillars are connected in series; and when n is greater than or equal to k, k primary-side windings in the n primary-side windings are respectively connected in parallel to k auxiliary inductor windings of the k second magnetic core pillars; or when n is less than k, each of the n primary-side windings is connected in parallel to at least one of the k auxiliary inductor windings; or k auxiliary inductor windings of the k second magnetic core pillars are connected in series and then are connected in parallel to the n primary-side windings that are connected in series; or k1 auxiliary inductor windings are connected in series and then are connected in parallel to n1 primary-side windings that are connected in series, and k2 auxiliary inductor windings are connected in series and then are connected in parallel to n2 primary-side windings that are connected in series, where k1+k2=k, n1+n2=n, k1, k2, n1, and n2 each are an integer greater than 0.

In a possible implementation, the auxiliary inductor winding and the primary-side winding are decoupled or weakly coupled.

Based on the design in this application, impact of mutual inductance between the auxiliary inductor winding and the primary-side winding of the transformer can be reduced.

In a possible implementation, the n first magnetic core pillars and the k second magnetic core pillars are arranged in a form of an array, and in a case of the top view in the direction from the first magnetic core cover to the second magnetic core cover, in the n first magnetic core pillars and the k second magnetic core pillars, winding directions of windings of two horizontally adjacent magnetic core pillars are opposite, and winding directions of windings of two perpendicularly adjacent magnetic core pillars are opposite.

In a possible implementation, the n first magnetic core pillars are disposed in a preset region, and the k second magnetic core pillars are distributed outside the preset region.

Based on the design in this application, cabling can be better performed.

According to a second aspect, this application provides a printed circuit board. The printed circuit board includes the planar transformer according to any one of the first aspect and the possible implementations of the first aspect.

According to a third aspect, this application provides an electronic device. The electronic device includes the planar transformer according to any one of the first aspect and the possible implementations of the first aspect.

### BRIEF DESCRIPTION OF DRAWINGS

FIG. 1 is a schematic diagram of a scenario of using a planar transformer according to this application;

FIG. 2A and FIG. 2B are schematic diagrams of a circuit principle of a planar transformer;

FIG. 3 is an equivalent schematic diagram of an inductor;

FIG. 4A is a schematic diagram of a structure of a magnetic core according to this application;

FIG. 4B is a schematic top view of a structure of a magnetic core according to this application;

FIG. 5 is a schematic diagram of a transmission direction of a magnetic flux in a magnetic core in a planar transformer according to this application;

FIG. 6 and FIG. 7 each are a schematic diagram of a transmission direction of a magnetic flux in a top view of a planar transformer according to this application;

FIGS. 8A and 8B are schematic diagrams of another circuit principle of a planar transformer;

FIG. 9A is a schematic diagram of a structure of another magnetic core according to this application;

FIG. 9B is a schematic top view of a structure of another magnetic core according to this application;

FIG. 10 is a schematic diagram of a transmission direction of a magnetic flux in a magnetic core in another planar transformer according to this application;

FIG. 11 and FIG. 12 each are a schematic diagram of a transmission direction of a magnetic flux in a top view of another planar transformer according to this application;

FIGS. 13A, 13B, and 13C are schematic diagrams of another circuit principle of a planar transformer; and

FIGS. 14A and 14B and FIGS. 15A and 15B each are a schematic diagram of a transmission direction of a magnetic flux in a top view of another planar transformer according to this application.

### DESCRIPTION OF EMBODIMENTS

The following describes embodiments of this application with reference to the accompanying drawings.

An application scenario of a planar transformer provided in this application is first described. For example, the planar transformer may be applied to an apparatus such as an aerospace power supply, a shipborne power supply, a radar power supply, a communication power supply, a motor vehicle or vehicle power supply, a computer or integrated chip power supply, a high-frequency heating or lighting power supply, a frequency converter, an inverter, various alternating current/direct current (AC/DC) converters, or a direct current/direct current (DC/DC) converter.

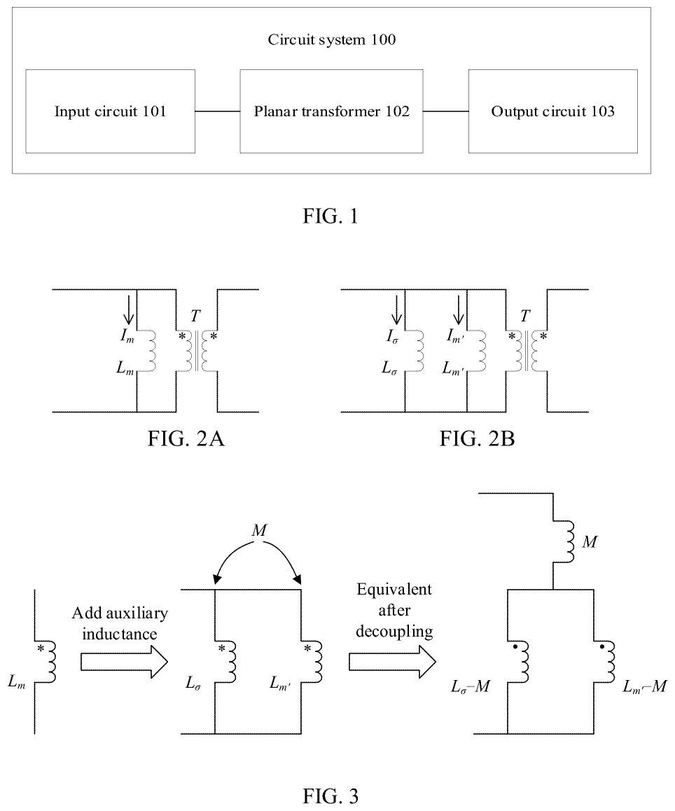

FIG. 1 is an example schematic diagram of a circuit system 100 in which the planar transformer is applied to the foregoing apparatus. The circuit system 100 includes an input circuit 101, a planar transformer 102, and an output circuit 103. The input circuit 101 may be connected to a power supply, and the power supply may be a direct current power supply or an alternating current power supply. The direct current power supply may be, for example, an energy storage battery (for example, a nickel cadmium (Ni—Cd) battery, a nickel metal hydride (NiMH) battery, a lithium-ion battery, or a lithium polymer battery) or a solar cell. The alternating current power supply may be a 220 volt (V) or 380 V power grid power supply, or the like. The planar transformer 102 is configured to convert (for example, boost or buck) a voltage obtained from the input circuit 101, and then the output circuit 103 outputs, to a corresponding load, a voltage obtained after conversion by the planar transformer 102, to supply power to the load. For example, the load may be a communication device (for example, a mobile phone), a computer (for example, a computer), or an electric vehicle.

The foregoing provides an example of the application scenario of the planar transformer provided in this application, but is not exhaustive. It should be understood that the planar transformer provided in this application is not limited to the foregoing voltage conversion scenario.

The following describes a structure of a planar transformer provided in this application.

FIGS. 2A and 2B are example diagrams of a circuit principle existing when a planar transformer includes only one pair of transformer windings. One pair of transformer windings includes one primary-side winding and one secondary-side winding of the transformer.

FIG. 2A is a diagram of a circuit principle of an existing planar transformer. Herein, Lₘ is excitation inductance generated when an excitation current Iₘ flows through a primary-side winding of a transformer T. To help understand this embodiment of this application, in this application, an excitation inductor Lₘ is represented as an example in the diagram of the circuit principle of the transformer.

FIG. 2B is a diagram of a circuit principle of a planar transformer according to this application. Herein, L_{m′} is excitation inductance generated after an excitation current I_{m′} is input into a primary-side winding of a transformer T, L_{σ} is inductance generated when a current I_{σ} flows through an auxiliary inductor winding, and L_{σ} may be referred to as auxiliary inductance. The auxiliary inductor winding is connected in parallel to the primary-side winding of the transformer T.

In a possible implementation, an excitation inductor L_{m′} and an auxiliary inductor L_{σ} that are connected in parallel in the planar transformer shown in FIG. 2B are equivalent to an excitation inductor Lₘ of the planar transformer shown in FIG. 2A. In addition, mutual inductance usually exists between the excitation inductor L_{m′} and the auxiliary inductor L_{σ}. For example, FIG. 3 shows an example relationship among L_{m′} L_{m′}, and L_{σ}. In FIG. 3, M is a mutual inductance coefficient between the excitation inductor L_{m′} and the auxiliary inductor L_{σ}. The relationship shown in FIG. 3 may be expressed as the following formula:

Lₘ—L_{σ}//L_{m′}=(L_{σ}×L_{m′}+M²)/(L_{σ}+L_{m′}−2×M)

Optionally, to reduce impact of mutual inductance, it may be designed that a relationship between the excitation inductor L_{m′} and the auxiliary inductor L_{σ} is a decoupling relationship or a weak coupling relationship.

In a possible implementation, it may be designed that magnetic flux linkage ψ_{σ} generated by the auxiliary inductor winding when the current I_{σ} flows through the auxiliary inductor winding is equal to magnetic flux linkage ψ_{m′} generated by the primary-side winding when the current I_{m′} flows through the primary-side winding of the transformer T. That is:

ψ_{σ}=ψ_{m′}

Because a magnetic flux p is a ratio of magnetic flux linkage p to a quantity N of turns of a winding,

φ_{σ}=ψ_{σ}/N_{σ}; and

φ_{m′}=ψ_{m′}/N_{m′}.

φ_{σ} is a magnetic flux that is of the auxiliary inductor winding and that exists when the current I_{σ} flows through the auxiliary inductor winding, φ_{m′} is a magnetic flux that is of the primary-side winding and that exists when the current I_{m′} flows through the primary-side winding of the transformer T, N_{σ} is a quantity of turns of the auxiliary inductor winding, and N_{m′} is a quantity of turns of the primary-side winding of the transformer T. It can be learned that, when the magnetic flux linkage of the auxiliary inductor winding is equal to the flux linkage of the primary-side winding of the transformer T, the following formula may be obtained:

φ_{σ}/φ_{m′}=N_{m′}/N_{σ}

In other words, a magnetic flux ratio between the auxiliary inductor winding and the primary-side winding of the transformer T may be controlled by controlling a turn ratio between the windings.

In addition, because a magnetic flux density B is a ratio of the magnetic flux p to an area Ae through which the magnetic flux φ perpendicularly passes,

B_{σ}=φ_{σ}/Ae_{σ}; and

B_{m′}=φ_{m′}/Ae_{m′}.

B_{σ} is a magnetic flux density existing when the magnetic flux φ_{σ} that is of the auxiliary inductor winding and that exists when the current I_{σ} flows through the auxiliary inductor winding perpendicularly passes through an area Ae_{σ}, and B_{m′} is a magnetic flux density existing when the magnetic flux φ_{m′} that is of the primary-side winding and that exists when the current I_{m′} flows through the primary-side winding of the transformer T perpendicularly passes through an area Ae_{m′}. To evenly transmit the magnetic flux, it may be set that B_{σ}—B_{m′}. Therefore, φ_{σ}/Ae_{σ}=φ_{m′}/Ae_{m′}. In other words, φ_{σ}/φ_{m′}=Ae_{σ}/Ae_{m′} In other words, N_{m′}/N_{σ}=Ae_{σ}/Ae_{m′}. It indicates that, when the magnetic flux densities are equal, a value of a cross-sectional area of the auxiliary inductor winding and a value of a cross-sectional area of the primary-side winding of the transformer T may be controlled by controlling the turn ratio between the windings.

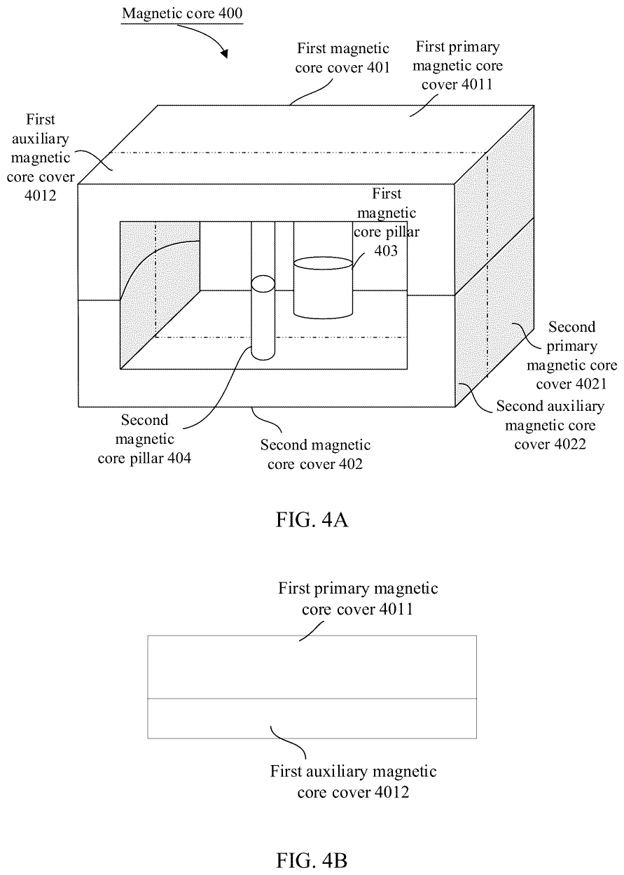

Based on the principles described in FIGS. 2A and 2B and FIG. 3, a magnetic core of a planar transformer provided in this application may be designed. FIG. 4A shows an example structure of a magnetic core 400 of a planar transformer according to an embodiment of this application. The magnetic core 400 includes a first magnetic core cover 401, a second magnetic core cover 402, a first magnetic core pillar 403, and a second magnetic core pillar 404. A structure of the first magnetic core cover 401 is symmetrical to a structure of the second magnetic core cover 402, the first magnetic core cover 401 includes a first primary magnetic core cover 4011 and a first auxiliary magnetic core cover 4012, and the second magnetic core cover 402 includes a second primary magnetic core cover 4021 and a second auxiliary magnetic core cover 4022. It should be noted that the first primary magnetic core cover 4011 and the first auxiliary magnetic core cover 4012 are integrally formed in a specific physical object. In FIG. 4A, a dashed line is drawn between the first primary magnetic core cover 4011 and the first auxiliary magnetic core cover 4012, to help distinguish between the two parts. Similarly, it should be noted that the second primary magnetic core cover 4021 and the second auxiliary magnetic core cover 4022 are integrally formed in a specific physical object. In FIG. 4A, a dashed line is drawn between the second primary magnetic core cover 4021 and the second auxiliary magnetic core cover 4022, to help distinguish between the two parts. Compared with an existing magnetic core, the structure shown in FIG. 4A additionally includes the first auxiliary magnetic core cover 4012, the second auxiliary magnetic core cover 4022, and the second magnetic core pillar 404. A function of the added second magnetic core pillar 404 is described in detail below, and details are not described herein.

In addition, a part that is of the first magnetic core cover 401 and the second magnetic core cover 402 and that is parallel to a magnetic core pillar may also be referred to as an edge pillar of the magnetic core.

It can be learned from FIG. 4A that the first magnetic core pillar 403 is disposed between the first primary magnetic core cover 4011 and the second primary magnetic core cover 4021, and is perpendicular to the first primary magnetic core cover 4011 and the second primary magnetic core cover 4021; and the second magnetic core pillar 404 is disposed between the first auxiliary magnetic core cover 4012 and the second auxiliary magnetic core cover 4022, and is perpendicular to the first auxiliary magnetic core cover 4012 and the second auxiliary magnetic core cover 4022.

In addition, in FIG. 4A, in a top view obtained through viewing in a direction from the first magnetic core cover 401 to the second magnetic core cover 402, for example, referring to FIG. 4B, an area of the first auxiliary magnetic core cover 4012 is less than an area of the first primary magnetic core cover 4011.

In a possible implementation, in the top view obtained through viewing in the direction from the first magnetic core cover 401 to the second magnetic core cover 402, the area of the first auxiliary magnetic core cover 4012 may alternatively be equal to the area of the first primary magnetic core cover 4011.

Optionally, the first magnetic core cover 401 and the second magnetic core cover 402 may be disassembled, and the first magnetic core pillar 403 and the second magnetic core pillar 404 may also be disassembled into two parts as the first magnetic core cover 401 and the second magnetic core cover 402 are disassembled.

A primary-side winding and a secondary-side winding of a transformer are disposed on the first magnetic core pillar 403 in the magnetic core 400, an auxiliary inductor winding is disposed on the second magnetic core pillar 404 in the magnetic core 400, the auxiliary inductor winding and the primary-side winding are connected in parallel, and a winding direction of the auxiliary inductor winding is opposite to a winding direction of the primary-side winding. In this way, the planar transformer provided in this application is obtained.

The winding direction of the auxiliary inductor winding and the winding direction of the primary-side winding may be, for example, as follows: The winding direction of the auxiliary inductor winding in the top view in the direction from the first magnetic core cover 401 to the second magnetic core cover 402 is a clockwise direction, and the winding direction of the primary-side winding in the top view is a counterclockwise direction; or the winding direction of the auxiliary inductor winding in the top view in the direction from the first magnetic core cover 401 to the second magnetic core cover 402 is a counterclockwise direction, and the winding direction of the primary-side winding in the top view is a clockwise direction.

After the planar transformer is powered on, because the auxiliary inductor winding and the primary-side winding are connected in parallel and winding directions of the windings are opposite, directions of magnetic fluxes generated by the auxiliary inductor winding and the primary-side winding are opposite. When the magnetic fluxes generated by the two windings are transmitted to a magnetic core cover through respective magnetic core pillars, the magnetic fluxes may be partially canceled because the directions are opposite, to reduce magnetic fluxes passing through the magnetic core cover. Because a magnetic flux density B is a ratio of a magnetic flux p to an area Ae through which the magnetic flux p perpendicularly passes, when the magnetic fluxes in the magnetic core cover decrease, a thickness of the magnetic core cover may be properly reduced, in other words, a cross-sectional area through which the magnetic fluxes in the magnetic core cover pass is reduced. In this way, an overall thickness of the planar transformer can be reduced without leading to magnetic saturation caused by an increase in a magnetic flux density of the magnetic core cover.

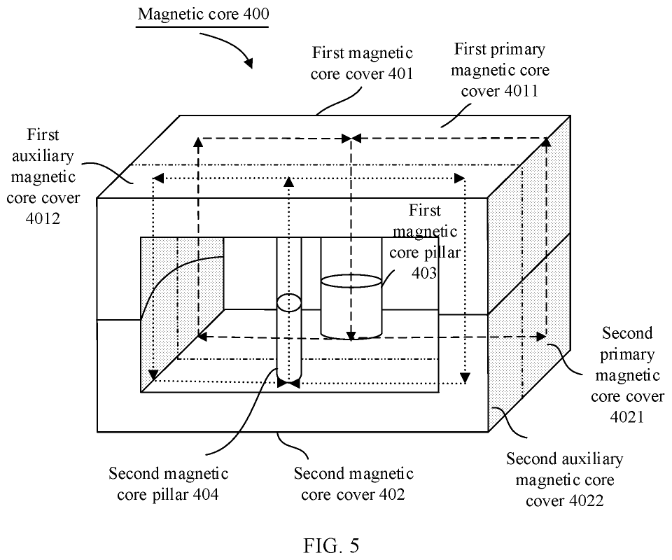

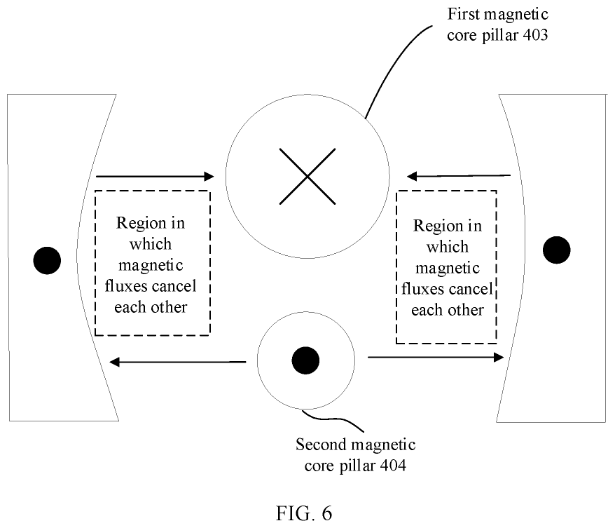

For example, refer to FIG. 5 and FIG. 6. FIG. 5 is a schematic diagram of a flow direction of a magnetic flux generated by an auxiliary inductor winding and a primary-side winding of a transformer after a planar transformer is powered on. It should be noted that, for brevity of the schematic diagram, the auxiliary inductor winding and the winding of the transformer are not drawn in FIG. 5. Actually, the primary-side winding and the secondary-side winding of the transformer are disposed on the first magnetic core pillar 403, and the auxiliary inductor winding is disposed on the second magnetic core pillar 404. It can be learned that the magnetic flux generated by the primary-side winding forms two magnetic flux loops through the first magnetic core cover 401 and the second magnetic core cover 402, and similarly, the magnetic flux generated by the auxiliary inductor winding also forms two magnetic flux loops through the first magnetic core cover 401 and the second magnetic core cover 402. In addition, the directions of the magnetic fluxes of the primary-side winding and the auxiliary inductor winding in the magnetic core cover are always opposite. Therefore, the magnetic flux of the auxiliary inductor winding in the magnetic core cover may partially cancel the magnetic flux of the primary-side winding. FIG. 6 is a top view in a direction from a first magnetic core cover 401 to a second magnetic core cover 402. A black dot in the figure represents a magnetic flux outflow page, a cross symbol represents a magnetic flux inflow page, and an arrow represents a magnetic flux flow direction. To be specific, a direction of a magnetic flux of the first magnetic core pillar 403 is opposite to a direction of a magnetic flux of the second magnetic core pillar 404, and a dashed-line box is a region in which magnetic fluxes cancel each other.

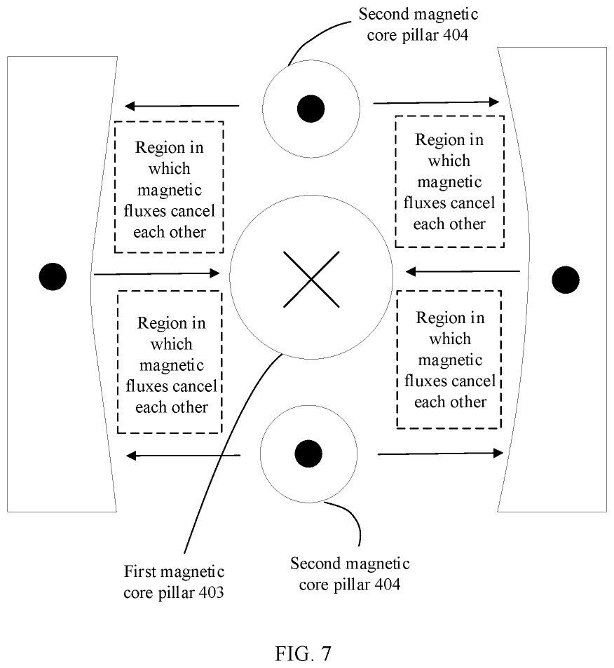

In a possible implementation, based on the magnetic core 400 shown in FIG. 4A, one second magnetic core pillar 404 may be further added. In the planar transformer provided in this application, the added second magnetic core pillar 404 is also provided with an auxiliary inductor winding, the auxiliary inductor winding is also connected in parallel to the primary-side winding of the transformer, and a direction of a magnetic flux generated after the auxiliary inductor winding is powered on is also opposite to a direction of a magnetic flux generated by the primary-side winding of the transformer in the first magnetic core pillar 403, so that the magnetic fluxes can cancel each other. Optionally, the newly added second magnetic core pillar 404 is symmetrical to the second magnetic core column 404 shown in FIG. 4A with respect to the first magnetic core pillar 403. For ease of understanding, refer to FIG. 7. FIG. 7 is a top view in a direction from a first magnetic core cover 401 to a second magnetic core cover 402. It can be learned that two second magnetic core pillars 404 are symmetrically disposed on two sides of the first magnetic core pillar 403, and directions of magnetic fluxes of the two second magnetic core pillars 404 are opposite to the direction of the magnetic flux of the first magnetic core pillar 403, so that the magnetic fluxes passing through the magnetic core cover can be partially canceled.

Optionally, in a comparison between the planar transformer shown in FIG. 7 and the transformer shown in FIG. 6, a total quantity of turns of auxiliary inductor windings disposed on the two second magnetic core pillars 404 in FIG. 7 may be equal to a quantity of turns of the auxiliary inductor winding disposed on the one second magnetic core pillar 404 in FIG. 6. For example, it is assumed that the quantity of turns of the auxiliary inductor winding disposed on the one second magnetic core pillar 404 in FIG. 6 is N1, a quantity of turns of an auxiliary inductor winding disposed on one second magnetic core pillar 404 in FIG. 7 is N1/2, and a quantity of turns of an auxiliary inductor winding disposed on the other second magnetic core pillar 404 is also N1/2. It can be learned, based on φ_{σ}/φ_{m′}=N_{m′}/N_{σ}, that, a quantity of turns of an auxiliary inductor winding may be determined based on a required magnetic flux. A specific quantity of turns of the auxiliary inductor winding is not limited in this application.

The foregoing describes a case in which a planar transformer includes only one pair of transformer windings. The following describes a case in which a planar transformer includes two pairs of transformer windings.

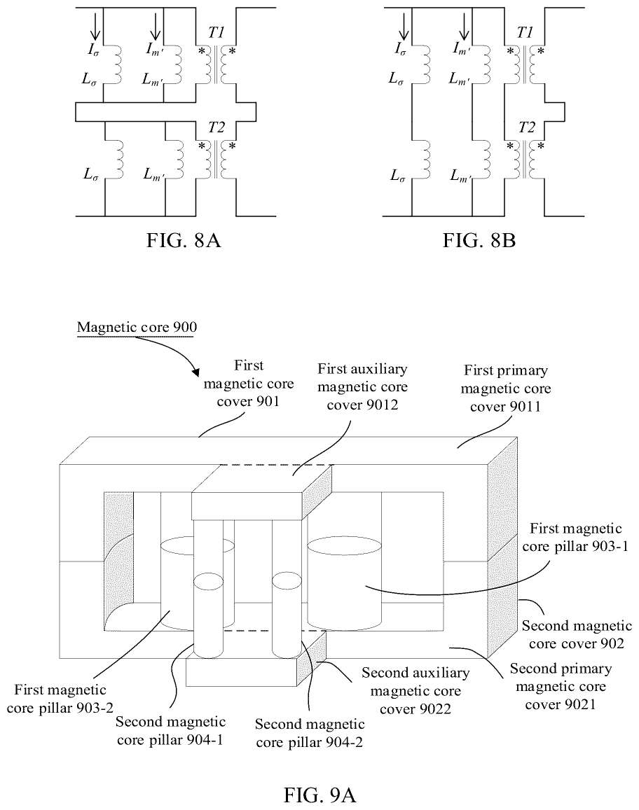

FIGS. 8A and 8B are example diagrams of a circuit principle of a planar transformer including two pairs of transformer windings according to this application. FIGS. 8A and 8B show two possible connection manners of an excitation inductor and an auxiliary inductor. In FIG. 8A, excitation inductors L_{m′} of the two pairs of transformer windings each are connected in parallel to one auxiliary inductor L_{σ}, and an excitation inductor L_{m′} of a transformer T1 and an auxiliary inductor L_{σ} are connected in parallel and then are connected in series to an excitation inductor L_{m′} of a transformer T2 and an auxiliary inductor L_{σ} that are connected in parallel. In a specific physical connection, one or more auxiliary inductor windings are connected in parallel to a primary-side winding of the transformer T1, other one or more auxiliary inductor windings are connected in parallel to a primary-side winding of the transformer T2, and then winding pairs obtained through parallel connection are connected in series.

In FIG. 8B, two auxiliary inductors L_{σ} are connected in series and then are connected in parallel to an excitation inductor L_{m′} of a transformer T1 and an excitation inductor L_{m′} of a transformer T2 that are connected in series. In a specific physical connection, at least two auxiliary inductor windings are connected in series, primary-side windings of two transformers are connected in series, and then the auxiliary inductor windings that are connected in series are connected in parallel to the primary-side windings that are connected in series.

Regardless of whether a connection manner shown in FIG. 8A or a connection manner shown in FIG. 8B is used, in a possible implementation, when power is supplied, a direction of a magnetic flux generated by each primary-side winding is opposite to a direction of a magnetic flux generated by a corresponding auxiliary inductor winding, so that the magnetic fluxes partially cancel each other.

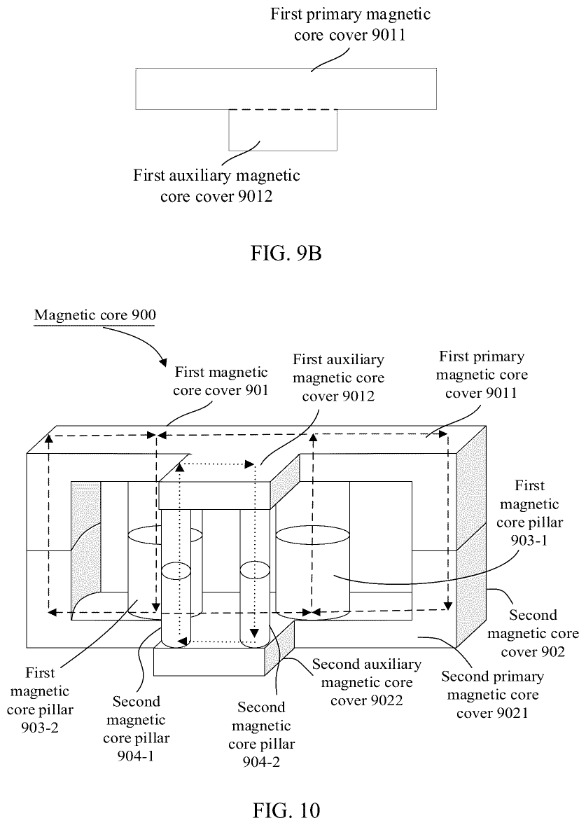

Based on the principle described in FIGS. 8A and 8B, a magnetic core of a planar transformer provided in this application may be designed. FIG. 9A shows an example structure of a magnetic core 900 of a planar transformer according to an embodiment of this application. The magnetic core 900 includes a first magnetic core cover 901, a second magnetic core cover 902, two first magnetic core pillars (903-1 and 903-2, where the first magnetic core pillar 903-1 and the first magnetic core pillar 903-2 may be collectively referred to as a first magnetic core pillar 903 below), and two second magnetic core pillars (904-1 and 904-2, where the second magnetic core pillar 904-1 and the second magnetic core pillar 904-2 may be collectively referred to as a second magnetic core pillar 904 below). A structure of the first magnetic core cover 901 is symmetrical to a structure of the second magnetic core cover 902, the first magnetic core cover 901 includes a first primary magnetic core cover 9011 and a first auxiliary magnetic core cover 9012, and the second magnetic core cover 902 includes a second primary magnetic core cover 9021 and a second auxiliary magnetic core cover 9022. It should be noted that the first primary magnetic core cover 9011 and the first auxiliary magnetic core cover 9012 are integrally formed in a specific physical object. In FIG. 9A, a dashed line is drawn between the first primary magnetic core cover 9011 and the first auxiliary magnetic core cover 9012, to help distinguish between the two parts. Similarly, it should be noted that the second primary magnetic core cover 9021 and the second auxiliary magnetic core cover 9022 are integrally formed in a specific physical object. In FIG. 9A, a dashed line is drawn between the second primary magnetic core cover 9021 and the second auxiliary magnetic core cover 9022, to help distinguish between the two parts. Compared with an existing magnetic core, the structure shown in FIG. 9A additionally includes the first auxiliary magnetic core cover 9012, the second auxiliary magnetic core cover 9022, and the second magnetic core pillar 904. A function of the added second magnetic core pillar 904 is described in detail below, and details are not described herein.

In addition, a part that is of the first magnetic core cover 901 and the second magnetic core cover 902 and that is parallel to a magnetic core pillar may also be referred to as an edge pillar of the magnetic core.

It can be learned from FIG. 9A that the first magnetic core pillar 903-1 and the first magnetic core pillar 903-2 are disposed between the first primary magnetic core cover 9011 and the second primary magnetic core cover 9021 and are perpendicular to the first primary magnetic core cover 9011 and the second primary magnetic core cover 9021; and the second magnetic core pillar 904-1 and the second magnetic core pillar 904-2 are disposed between the first auxiliary magnetic core cover 9012 and the second auxiliary magnetic core cover 9022, and are perpendicular to the first auxiliary magnetic core cover 9012 and the second auxiliary magnetic core cover 9022.

In addition, in FIG. 9A, in a top view obtained through viewing in a direction from the first magnetic core cover 901 to the second magnetic core cover 902, for example, referring to FIG. 9B, an area of the first auxiliary magnetic core cover 9012 is less than an area of the first primary magnetic core cover 9011.

In a possible implementation, in the top view obtained through viewing in the direction from the first magnetic core cover 901 to the second magnetic core cover 902, the area of the first auxiliary magnetic core cover 9012 may alternatively be equal to the area of the first primary magnetic core cover 9011.

Optionally, the first magnetic core cover 901 and the second magnetic core cover 902 may be disassembled, and the first magnetic core pillar 903 and the second magnetic core pillar 904 may also be disassembled into two parts as the first magnetic core cover 901 and the second magnetic core cover 902 are disassembled.

The planar transformer that includes two pairs of transformer windings and that is provided in this application may be obtained through disposing performed as follows: A primary-side winding and a secondary-side winding of one pair of transformer windings are disposed on the first magnetic core pillar 903-1, a primary-side winding and a secondary-side winding of another pair of transformer windings are disposed on the first magnetic core pillar 903-2, and one auxiliary inductor winding is disposed on each of the second magnetic core pillar 904-1 and the second magnetic core pillar 904-2. For a connection manner of the two auxiliary inductor windings and the two primary-side windings, refer to the connection manner shown in FIG. 8A or FIG. 8B. Regardless of a specific connection manner that is used, winding directions of windings of two of the four magnetic core pillars are a first direction, winding directions of the other two magnetic core pillars are a second direction, and the second direction and the first direction are opposite directions. For example, in the top view in the direction from the first magnetic core cover 901 to the second magnetic core cover 902, the first direction is a counterclockwise direction, and the second direction is a clockwise direction; or the first direction is a clockwise direction, and the second direction is a counterclockwise direction.

After the planar transformer including the two pairs of transformer windings is powered on, directions of magnetic fluxes generated by windings with a same winding direction are the same, and directions of magnetic fluxes generated by windings with opposite winding directions are opposite. When the magnetic fluxes are transmitted to a magnetic core cover through respective magnetic core pillars, magnetic fluxes passing through the magnetic core cover are reduced because magnetic fluxes in opposite directions may be partially canceled, to properly reduce a thickness of the magnetic core cover, in other words, to reduce a cross-sectional area through which magnetic fluxes in the magnetic core cover pass. In this way, an overall thickness of the planar transformer can be reduced without leading to magnetic saturation of the magnetic core cover.

For example, refer to FIG. 10. FIG. 10 is a schematic diagram of a flow direction of a magnetic flux generated by an auxiliary inductor winding and a primary-side winding of a transformer after a planar transformer is powered on. It should be noted that, for brevity of the schematic diagram, the auxiliary inductor winding and the winding of the transformer are not drawn in FIG. 10. Actually, a primary-side winding and a secondary-side winding of the transformer are disposed on each of the first magnetic core pillar 903-1 and the first magnetic core pillar 903-2, and an auxiliary inductor winding is disposed on each of the second magnetic core pillar 904-1 and the second magnetic core pillar 904-2.

It can be learned from FIG. 10 that, directions of magnetic fluxes generated by windings of the first magnetic core pillar 903-1 and the second magnetic core pillar 904-1 are flowing out of the magnetic core pillars in a direction to the first magnetic core cover 901, and directions of magnetic fluxes generated by windings of the first magnetic core pillar 903-2 and the second magnetic core pillar 904-2 are flowing out of the magnetic core pillars in a direction to the second magnetic core cover 902. In addition to a magnetic flux loop that may be provided between the two magnetic core covers for a magnetic flux, there is a magnetic flux loop that may be provided, by a magnetic core pillar other than a magnetic core pillar that generates a magnetic flux, for the generated magnetic flux. Therefore, a magnetic flux flowing out of a magnetic core pillar may flow back to the magnetic core pillar through a plurality of paths. In other words, a magnetic flux generated on one magnetic core pillar may have a plurality of magnetic flux loops on the magnetic core. FIG. 10 shows an example of a partial magnetic flux loop. It should be noted that the direction of the magnetic flux and the magnetic flux loop shown in FIG. 10 are merely examples, and do not constitute a limitation on this application.

Because the magnetic flux is usually transmitted through a close magnetic flux loop, in FIG. 10, most of magnetic fluxes generated on the first magnetic core pillar 903-1 flow back through the first magnetic core pillar 903-2 and an edge pillar that is of the magnetic core and that is close to the first magnetic core pillar 903-2, and such two loops disperse the magnetic fluxes generated on the first magnetic core pillar 903-1; and similarly, most of magnetic fluxes generated on the first magnetic core pillar 903-2 flow back through the first magnetic core pillar 903-1 and an edge pillar that is of the magnetic core and that is close to the first magnetic core pillar 903-1, and such two loops disperse the magnetic fluxes generated on the first magnetic core pillar 903-2. However, for the second magnetic core pillar 904-1 and the second magnetic core pillar 904-2, because a first magnetic core pillar and an edge pillar of the magnetic core are far, a small quantity of magnetic fluxes flow to the first magnetic core pillar and the edge pillar of the magnetic core. Therefore, most of magnetic fluxes generated on the second magnetic core pillar 904-1 flow back through the second magnetic core pillar 904-2, and most of magnetic fluxes generated on the second magnetic core pillar 904-2 flow back through the second magnetic core pillar 904-1. In this case, there are a small quantity of magnetic fluxes on the edge pillar of the magnetic core. Therefore, a thin thickness may be designed. For a part that is of a magnetic core cover and that has a large quantity of magnetic fluxes, in this application, an auxiliary inductor winding of a second magnetic core pillar generates a reverse magnetic flux to cancel a part of the magnetic fluxes. Therefore, the thickness of the magnetic core cover can also be reduced, so that the thickness of the entire magnetic core cover can be reduced. This principle is applicable to a structure of another magnetic core provided in this application. Herein, only the structure of the magnetic core shown in FIG. 10 is used as an example for description.

FIG. 11 is a top view in a direction from a first magnetic core cover 901 to a second magnetic core cover 902 in FIG. 10. In the figure, a black dot represents a magnetic flux outflow page, a cross symbol represents a magnetic flux inflow page, and a dashed-box arrow represents a direction in which a magnetic flux flows. An arrangement manner of magnetic core pillars shown in FIG. 11 is a matrix arrangement manner. However, in this application, an arrangement manner of a plurality of magnetic core pillars in the magnetic core may be another array arrangement manner, for example, a rhombic arrangement manner, or is not limited to an array arrangement manner. The arrangement manner of the plurality of magnetic core pillars is not limited in this application. It can be learned from FIG. 11 that, in four magnetic core pillars arranged in a matrix form, directions of magnetic fluxes of two horizontally adjacent magnetic core pillars are opposite, and direction of magnetic fluxes of two perpendicularly adjacent magnetic core pillars are opposite, so that a direction of a magnetic flux between the first magnetic core pillar 903-1 and the first magnetic core pillar 903-2 on the magnetic core cover is opposite to a direction of a magnetic flux between the second magnetic core pillar 904-1 and the second magnetic core pillar 904-2. Therefore, the magnetic flux between the second magnetic core pillar 904-1 and the second magnetic core pillar 904-2 can partially cancel the magnetic flux between the first magnetic core pillar 903-1 and the first magnetic core pillar 903-2. In other words, the magnetic fluxes passing through the magnetic core cover are reduced. In FIG. 11, a region in which a dashed-line rectangular box is located is a region in which magnetic fluxes are canceled.

In a possible implementation, based on the magnetic core 900 shown in FIG. 9A, two second magnetic core pillars may be further added. In the planar transformer provided in this application, the two added second magnetic core pillars each are also provided with an auxiliary inductor winding.

Optionally, the two newly added auxiliary inductor windings are respectively connected in parallel to a primary-side winding of a transformer T1 and a primary-side winding of a transformer 72, and a direction of a magnetic flux generated after an auxiliary inductor winding is powered on is also opposite to a direction of a magnetic flux generated by a primary-side winding connected in parallel to the auxiliary inductor winding, so that magnetic fluxes can cancel each other.

Alternatively, optionally, the two newly added auxiliary inductor windings continue to be connected in series to two auxiliary inductor windings that are originally connected in series, the four auxiliary inductor windings are connected in series and then are connected in parallel to primary-side windings that are of two transformers and that are connected in series, and a direction of a magnetic flux generated by each primary-side winding is opposite to a direction of a magnetic flux generated by two corresponding auxiliary inductor windings, so that the magnetic fluxes can cancel each other better.

A quantity of turns of an auxiliary inductor winding may still be determined based on a required magnetic flux based on the foregoing equation φ_{σ}/φ_{m′}=N_{m′}/N_{σ}. A specific quantity of turns of the auxiliary inductor winding is not limited in this application.

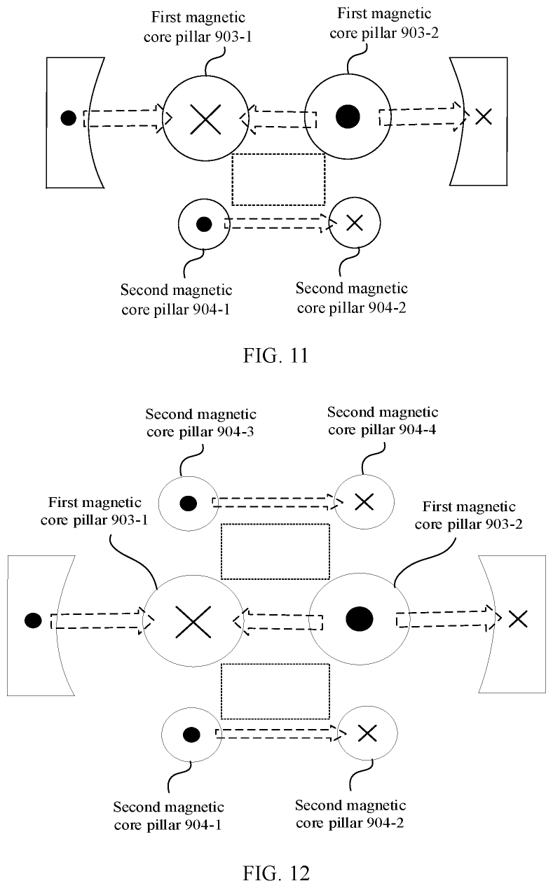

Optionally, one of the newly added second magnetic core pillars is symmetrical to the second magnetic core column 904-1 shown in FIG. 9A with respect to the first magnetic core pillar 903-1. The other one of the newly added second magnetic core pillars is symmetrical to the second magnetic core column 904-2 shown in FIG. 9A with respect to the first magnetic core pillar 903-2. For ease of understanding, refer to FIG. 12. FIG. 12 is a top view in a direction from a first magnetic core cover 901 to a second magnetic core cover 902. It can be learned that the two newly added second magnetic core pillars are a second magnetic core pillar 904-3 and a second magnetic core pillar 904-4. The second magnetic core pillar 904-3 and the second magnetic core pillar 904-1 are symmetrical with respect to the first magnetic core pillar 903-1, and the second magnetic core pillar 904-4 and the second magnetic core pillar 904-2 are symmetrical with respect to the first magnetic core pillar 903-2. In addition, a direction of a magnetic flux generated on the second magnetic core pillar 904-3 is opposite to a direction of a magnetic flux of the first magnetic core pillar 903-1, and a direction of a magnetic flux generated on the second magnetic core pillar 904-4 is opposite to a direction of a magnetic flux of the first magnetic core pillar 903-2, so that the magnetic fluxes passing through the magnetic core cover can be partially canceled. In FIG. 12, a region in which a dashed-line rectangular box is located is a region in which magnetic fluxes are canceled.

This application may provide a planar transformer including n pairs of transformer windings, where n may be an integer greater than 0. When n is 1, the planar transformer is the planar transformer described in FIG. 2A to FIG. 7. When n is 2, the planar transformer is the planar transformer described in FIG. 8A to FIG. 12.

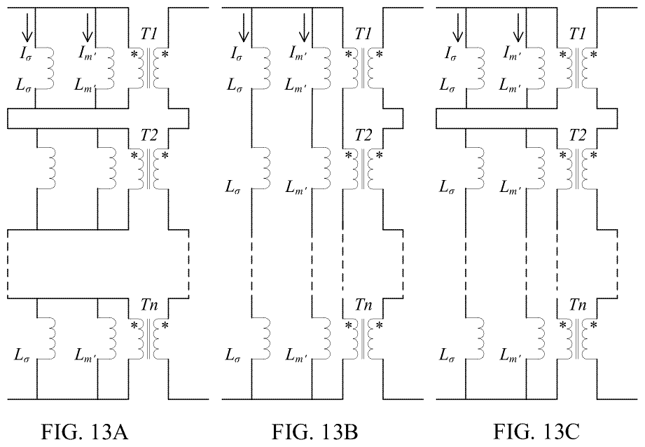

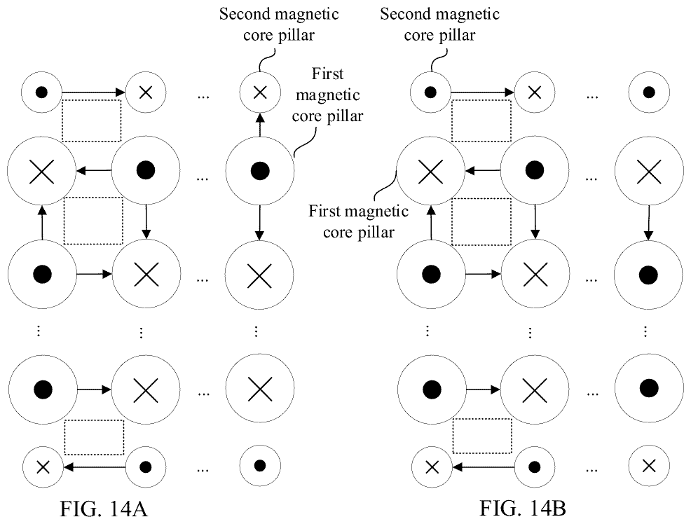

FIGS. 13A-13C are example diagrams of a circuit principle of a planar transformer including at least two pairs of transformer windings according to this application. FIGS. 13A-13C show three possible connection manners of an excitation inductor and an auxiliary inductor. In FIG. 13A, excitation inductors L_{m′} of n pairs of transformer windings each are connected in parallel to one auxiliary inductor L_{σ}, to obtain n groups of parallel inductors, and the n groups of parallel inductors are connected in series. In a specific physical connection, n groups of parallel windings are obtained after n primary-side windings of transformers each are connected in parallel to a respective auxiliary inductor winding, and the n groups of parallel windings are connected in series.

In FIG. 13B, n auxiliary inductors L_{σ} are connected in series and then are connected in parallel to excitation inductors of primary-side windings that are of transformers and that are connected in series. In a specific physical connection, n auxiliary inductor windings are connected in series, n primary-side windings of transformers are connected in series, and then the auxiliary inductor windings that are connected in series are connected in parallel to the primary-side windings that are connected in series.

In addition to connection manners shown in FIGS. 13A-13B, in a possible implementation, a connection manner of the n auxiliary inductor windings and primary-side windings of n transformers may be as follows: Some auxiliary inductor windings are connected in series and then are connected in parallel to some primary-side windings that are connected in series, and the remaining auxiliary inductor windings are also connected in series and then are connected in parallel to the other primary-side windings that are connected in series. For ease of understanding, for example, refer to FIG. 13C. It can be learned that an excitation inductor L_{m′} of a transformer T1 is connected in parallel to one auxiliary inductor L_{σ}, the remaining n−1 auxiliary inductors L_{σ} are connected in series, excitation inductors L_{m′} of a transformer T2 to a transformer Tn are connected in series, the auxiliary inductors L_{σ} that are connected in series are connected in parallel to the excitation inductors L_{m′} that are connected in series, and the two groups of parallel inductors are connected in series. A connection manner shown in FIG. 13C is merely an example. The connection manner may alternatively be that p auxiliary inductors are connected in series and then are connected in parallel to p excitation inductors that are connected in series, n-p auxiliary inductors are connected in series and then are connected in parallel to n-p excitation inductors that are connected in series, and the two groups of parallel inductors are connected in series. Herein, p is an integer greater than 1 and less than n. In a specific physical connection, the auxiliary inductor is replaced with an auxiliary inductor winding, and the excitation inductor is replaced with a primary-side winding of a transformer.

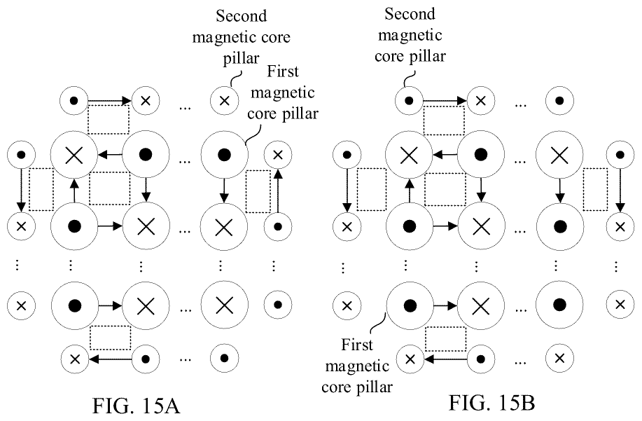

Regardless of a specific connection manner in the foregoing connection manners, in a possible implementation, when power is supplied, a direction of a magnetic flux generated by each primary-side winding is opposite to a direction of a magnetic flux generated by a corresponding auxiliary inductor winding, so that the magnetic fluxes partially cancel each other. In addition, primary-side windings may also generate magnetic fluxes in opposite directions, so that magnetic fluxes passing through a magnetic core cover can be reduced. For ease of understanding, for example, the following provides further descriptions by using an example in which n is k². Herein, k is an integer greater than 1. FIGS. 14A-14B and FIGS. 15A-15B each are a schematic diagram of a direction of a magnetic flux on a first magnetic core pillar and a direction of a magnetic flux on a second magnetic core pillar in a magnetic core. It should be noted that the magnetic core still includes a first magnetic core cover and a second magnetic core cover (for example, reference may be made to a first magnetic core cover and a second magnetic core cover shown in FIG. 10, or the like), which are not shown in FIGS. 14A-14B and FIGS. 15A-15B.

First, FIG. 14A is a schematic diagram of a direction of a magnetic flux when k is an even number, and FIG. 14B is a schematic diagram of a direction of a magnetic flux when k is an odd number. It can be learned that magnetic core pillars in the magnetic core may be arranged in a matrix manner, and include k² first Magnetic core pillars. 2×k second magnetic core pillars are disposed on two opposite sides of the k² first magnetic core pillars, and k second magnetic core pillars are disposed on each of the two sides. One primary-side winding and one secondary-side winding of a transformer are disposed on each first magnetic core pillar, one auxiliary inductor winding is disposed on each second magnetic core pillar, directions of magnetic fluxes generated by windings of two horizontally adjacent magnetic core pillars are opposite, and directions of magnetic fluxes generated by windings of two perpendicularly adjacent magnetic core pillars are opposite, so that the magnetic fluxes can partially cancel each other. In FIGS. 14A-14B, a region in which a dashed-line rectangular box is located is a region in which magnetic fluxes are canceled.

FIG. 15A is a schematic diagram of a direction of a magnetic flux when k is an even number, and FIG. 15B is a schematic diagram of a direction of a magnetic flux when k is an odd number. It can be learned that, compared with FIGS. 14A-14B, in FIGS. 15A-15B, second magnetic core pillars are disposed around a first magnetic core pillar matrix, directions of magnetic fluxes generated by windings of two horizontally adjacent magnetic core pillars are opposite, and directions of magnetic fluxes generated by windings of two perpendicularly adjacent magnetic core pillars are opposite, so that more magnetic fluxes can be canceled, and the magnetic core cover can be designed to be thinner. In FIGS. 15A-15B, a region in which a dashed-line rectangular box is located is a region in which magnetic fluxes are canceled.

It should be noted that an arrangement manner of the magnetic core pillars shown in the figure is a matrix arrangement manner. However, in this application, an arrangement manner of a plurality of magnetic core pillars in the magnetic core may be another array arrangement manner, for example, a rhombic arrangement manner, or is not limited to an array arrangement manner. The arrangement manner of the plurality of magnetic core pillars is not limited in this application.

In the foregoing embodiment, it can be learned that the first magnetic core pillar is disposed in a preset region, and the second magnetic core pillar is distributed outside the preset region. In a possible implementation, in the planar transformer provided in this application, the second magnetic core pillar is not limited to being designed to be on the periphery of the preset region in which the first magnetic core pillar is located, or may be designed to be in a gap between first magnetic core pillars in the preset region, or the first magnetic core pillar and the second magnetic core pillar are arranged in an alternate manner, or the like.

In a possible implementation, in FIGS. 14A-14B and FIGS. 15A-15B, a quantity of second magnetic core pillars may be less than a quantity of first magnetic core pillars. However, a quantity of generated magnetic fluxes may be increased by disposing more auxiliary inductor windings of the second magnetic core pillar, or disposing more turns of the auxiliary inductor winding of the second magnetic core pillar, to achieve required cancellation between magnetic fluxes on the magnetic core cover.

In a possible implementation, a cross-sectional area of the first magnetic core pillar may be the same as a cross-sectional area of the second magnetic core pillar, or a cross-sectional area of the second magnetic core pillar may be less than a cross-sectional area of the first magnetic core pillar. When the cross-sectional area of the second magnetic core pillar is less than the cross-sectional area of the first magnetic core pillar, an area occupied by the magnetic core can be reduced, and material costs can be reduced.

In a possible implementation, it can be learned from the principle description content that, to evenly transmit the magnetic flux, B_{σ}=B_{m′}. To be specific, a density of a magnetic flux generated by a winding of the first magnetic core pillar is the same as a density of a magnetic flux generated by a winding of the second magnetic core pillar. In this case, N_{m′}/N_{σ}=Ae_{σ}/Ae_{m′}. To be specific, a cross-sectional area ratio of the second magnetic core pillar to the first magnetic core pillar is equal to a ratio of a quantity of turns of the auxiliary inductor winding of the second magnetic core pillar to a quantity of turns of the primary-side winding of the first magnetic core pillar. Therefore, Ae_{σ}=Ae_{m′}×N_{m′}/N_{σ}. To be specific, the cross-sectional area of the second magnetic core pillar is N_{m′}/N_{σ} times of the cross-sectional area of the first magnetic core pillar. For example, it is assumed that N_{m′}=18, N_{σ}=54, and N_{m′}/N_{σ}=1/3. To be specific, the cross-sectional area of the second magnetic core pillar is ⅓ of the cross-sectional area of the first magnetic core pillar.

In this application, it may be set that the quantity of turns of the auxiliary inductor winding of the second magnetic core pillar is greater than the quantity of turns of the primary-side winding of the first magnetic core pillar. For example, it may be set that the quantity of turns of the auxiliary inductor winding is two times, three times, or four times of the quantity of turns of the primary-side winding. Because an inductance value is directly proportional to a square of a quantity of turns of a winding, and more turns indicate a greater inductance value, a smaller current flowing through the auxiliary inductor winding leads to a smaller generated winding loss.

In a possible implementation, the auxiliary inductor winding and the transformer winding disposed on the magnetic core pillar may be a wound winding or a printed circuit board winding.

It should be noted that, in this application, a design in which a second magnetic core pillar is added to a magnetic core to dispose an auxiliary inductor winding, so as to reduce magnetic fluxes passing through a magnetic core cover may be applied to various types of magnetic cores, for example, an ER type, an RM type, an EI type, an EP type, a PQ type, or an EE type. In the foregoing embodiments, descriptions are mainly provided by using an ER-type magnetic core as an example, but this does not constitute a limitation on this application. In addition, optionally, a shape of the magnetic core pillar may be a circle, an ellipse, a crescent, a polyhedral, or the like. This is not limited in this application.

In a possible implementation, in the planar transformer provided in this application, the primary-side winding of the first magnetic core pillar may not be electrically connected to the auxiliary inductor winding of the second magnetic core pillar. One power supply may be disposed to power on the primary-side winding of the first magnetic core pillar, and another power supply may be disposed to power on the auxiliary inductor winding of the second magnetic core pillar. In this implementation, magnetic fluxes in the magnetic core cover can also be canceled. In this embodiment of this application, cabling may be flexibly performed better in some cases, for example, when cabling on a printed circuit board is difficult.

In addition, for example, Table 1 shows an example of a comparison between a parameter of a planar transformer provided in this application and a parameter of an existing planar transformer.

TABLE 1

| | Parameter of an | | Parameter of a planar | | |
|---|---|---|---|---|---|
| | existing planar | | transformer provided in | | |
| Dimension | transformer | | this application | | Change |
| Total thickness of | 9.7 millimeters | | 8.5 | mm | Decreased |
| a magnetic core | (mm) | | | | by 12% |
| Thickness of a | 2.9 | mm | 2.3 | mm | |
| magnetic core | | | | | |
| cover | | | | | |
| Total loss of a | 2.56 watts | | 2.61 | W | Increased |
| transformer | (W) | | | | by 2% |
| Loss of a | 1.8 | W | 1.85 | W | |
| magnetic core | | | | | |
| Winding loss | 0.76 | W | 0.76 | W | |

It can be learned from Table 1 that, according to the planar transformer provided in this application, the total thickness of the magnetic core can be decreased by 12% by increasing the total loss by only 2%. In other words, the thickness of the magnetic core can be greatly decreased only by paying a small loss cost.

In addition, compared with the existing planar transformer, in the planar transformer provided in this application, an area occupied by the magnetic core of the planar transformer (for example, in a top view in a direction from a first magnetic core cover to a second magnetic core cover, an area occupied by the first magnetic core cover is an area occupied by the magnetic core) is slightly increased. For example, referring to FIG. 4A and FIG. 9A, an increased area is an area occupied by a first auxiliary magnetic core cover. However, in a design in this application, it may be designed that an area occupied by a first auxiliary magnetic core cover is less than an area occupied by a first primary magnetic core cover. In this case, an increased area occupied by the magnetic core is small. In other words, in this application, a thickness of the magnetic core can be greatly reduced only by paying a small cost of the area occupied by the magnetic core.

In conclusion, in this application, compared with an existing planar transformer, a second magnetic core pillar is added to dispose an auxiliary inductor winding, so as to generate a magnetic flux opposite to that of the primary-side winding of the transformer, so that magnetic fluxes passing through the magnetic core cover are reduced, and a thickness of the magnetic core cover can be further reduced.

In addition, compared with an existing technical solution, in this application, in a design of a planar transformer that outputs a small current, the magnetic fluxes passing through the magnetic core cover may also be reduced, so that the thinner magnetic core cover can be designed, to better satisfy the design of the ultra-thin product. For example, the planar transformer that outputs a small current may be a planar transformer (for example, any one of the planar transformers provided in this application in FIG. 2A to FIG. 12) that includes only one or two pairs of transformer windings. Certainly, the planar transformer that outputs a small current may alternatively be a planar transformer including three pairs of transformer windings, or the like.

This application further provides a printed circuit board. The printed circuit board includes any one of the foregoing described planar transformers.

This application further provides an electronic device. The electronic device includes any one of the foregoing described planar transformers.

In this application, terms such as “first” and “second” are used to distinguish same items or similar items that have basically same effects and functions. It should be understood that there is no logical or time sequence dependency between “first”, “second”, and “n^{th}”, and a quantity and an execution sequence are not limited. It should be further understood that although terms such as “first” and “second” are used in the following descriptions to describe various elements, these elements should not be limited by the terms. These terms are merely used to distinguish one element from another element. For example, without departing from a scope of the various examples, a first magnetic core cover may be referred to as a second magnetic core cover, and similarly, a second magnetic core cover may be referred to as a first magnetic core cover. Both the first magnetic core cover and the second magnetic core cover may be magnetic core covers, and in some cases, may be separate and different magnetic core covers.

It should be further understood that sequence numbers of processes do not mean execution sequences in embodiments of this application. The execution sequences of the processes should be determined based on functions and internal logic of the processes, and should not be construed as any limitation on the implementation processes of embodiments of this application.

It should be further understood that the term “include” (also referred to as “includes”, “including”, “comprises”, and/or “comprising”) used in this specification specifies presence of the stated features, integers, steps, operations, elements, and/or components, with presence or addition of one or more other features, integers, steps, operations, elements, components, and/or a group thereof not excluded.

It should further be understood that “one embodiment”, “an embodiment”, or “a possible implementation” mentioned throughout this specification means that particular features, structures, or characteristics related to the embodiments or implementations are included in at least one embodiment of this application. Therefore, “in one embodiment”, “in an embodiment”, or “in a possible implementation” appearing throughout this specification does not necessarily mean a same embodiment. In addition, these particular features, structures, or characteristics may be combined in one or more embodiments by using any proper manner.

Finally, it should be noted that the foregoing embodiments are merely intended for describing the technical solutions of this application other than limiting this application. Although this application is described in detail with reference to the foregoing embodiments, persons of ordinary skill in the art should understand that they may still make modifications to the technical solutions described in the foregoing embodiments or make equivalent replacements to some or all technical features thereof, without departing from the scope of the technical solutions of embodiments of this application.

1. A planar transformer, comprising:
a magnetic core comprising:
a first magnetic core cover;
a second magnetic core cover;
n first magnetic core pillars perpendicularly disposed between the first magnetic core cover and the second magnetic core cover, wherein n is an integer greater than 0; and
k second magnetic core pillars perpendicularly disposed between the first magnetic core cover and the second magnetic core cover, wherein k is an integer greater than 0;
n primary-side windings respectively disposed on the n first magnetic core pillars and configured to generate a second magnetic flux when the n primary-side windings receive power;
n secondary-side windings respectively disposed on the n first magnetic core pillars and respectively coupled to the n primary-side windings; and
k auxillary inductor windings respectively disposed on the k second magnetic core pillars and configured to generate a first magnetic flux when the k auxiliary inductor windings power,
wherein when the planar transformer receives power the first magnetic flux cancels a part of the second magnetic flux when the first magnetic flux passes through the first magnetic core cover and the second magnetic core cover.

2. The planar transformer of claim 1, wherein the first magnetic core cover is symmetrical to the second magnetic core cover, wherein the first magnetic core cover comprises a first primary magnetic core cover and a first auxiliary magnetic core cover, wherein the second magnetic core cover comprises a second primary magnetic core cover and a second auxiliary magnetic core cover, wherein the first auxiliary magnetic core comprises a first area based on a top view obtained by viewing the planar transformer in a direction from the first magnetic core cover to the second magnetic core cover, wherein the first primary magnetic core cover comprises a second area based on the top view, and wherein the first area is less than the second area, and wherein the n first magnetic core pillars and the k second magnetic core pillars being disposed between the first magnetic core cover and the second magnetic core cover comprises:
the n first magnetic core pillars being disposed between the first primary magnetic core cover and the second primary magnetic core cover and being perpendicularly connected to the first primary magnetic core cover and the second primary magnetic core cover; and
the k second magnetic core pillars being disposed between the first auxiliary magnetic core cover and the second auxiliary magnetic core cover and being perpendicularly connected to the first auxiliary magnetic core cover and the second auxiliary magnetic core cover.

3. The planar transformer of claim 1, wherein a first cross-sectional area of one of the k second magnetic core pillars is less than a second cross-sectional area of one of the n first magnetic core pillars.

4. The planar transformer of claim 1, wherein a first cross-sectional area ratio of one of the n first magnetic core pillars to one of the k second magnetic core pillars is equal to a second ratio of a quantity of turns of an auxiliary inductor winding of one of the k second magnetic core pillars to a quantity of turns of a primary-side winding of one of the n first magnetic core pillars.

5. The planar transformer of claim 1, wherein a quantity of turns of the k auxiliary inductor windings is greater than a quantity of turns of the n primary-side windings.

6. The planar transformer of claim 1, wherein the k auxiliary inductor windings are electrically connected to the n primary-side windings.

7. The planar transformer of claim 6, wherein the n primary-side windings of the n first magnetic core pillars are connected in series, and
wherein when n is greater than or equal to k, k primary-side windings in the n primary-side windings are respectively connected in parallel to the k auxiliary inductor windings of the k second magnetic core pillars, or
wherein when n is less than k, each of the n primary-side windings is connected in parallel to at least one of the k auxiliary inductor windings, or
wherein the k auxiliary inductor windings are connected in series to each other and are connected in parallel to the n primary-side windings, or
wherein k1 auxiliary inductor windings are connected in series to each other, wherein n1 primary-side windings are connected in series to each other, wherein the k1 auxiliary inductor windings are connected in parallel to the n1 primary-side windings, wherein k2 auxiliary inductor windings are connected in series to each other, wherein n2 primary-side windings are connected in series to each other, wherein the k2 auxiliary inductor windings are connected in parallel to the n2 primary-side windings, and wherein k1+k2=k, n1+n2=n, k1, k2, n1, and n2 each are an integer greater than 0.

8. The planar transformer of claim 1, wherein the k auxiliary inductor windings and the n primary-side windings are decoupled or weakly coupled.

9. The planar transformer of claim 1, wherein the n first magnetic core pillars and the k second magnetic core pillars are arranged in a form of an array, wherein winding directions of windings of two horizontally adjacent magnetic core pillars are opposite, and wherein winding directions of windings of two perpendicularly adjacent magnetic core pillars are opposite.

10. (canceled)

11. A printed circuit board comprising:
a planar transformer comprising:
a magnetic core comprising:
a first magnetic core cover;
a second magnetic core cover;
n first magnetic core pillars perpendicularly disposed bet ween the first magnetic core cover and the second magnetic core cover, wherein n is an integer greater than 0; and
k second magnetic core pillars perpendicularly disposed between the first magnetic core cover and the second magnetic core cover wherein k is an integer greater than 0;
n primary-side windings respectively disposed on the n first magnetic core pillars and configured to generate a second magnetic flux when the n primary-side windings receive power;
n secondary-side windings respectively disposed on the n first magnetic core pillars and respectively coupled to the n primary-side windings; and
k auxiliary inductor windings respectively disposed on the k second magnetic core pillars and configured to generate a first magnetic flux when the k auxiliary inductor windings receive power,
wherein when the planar transformer receives power, the first magnetic flux cancels a part of the second magnetic flux when the first magnetic flux passes through the first magnetic core cover and the second magnetic core cover.

12. The printed circuit board of claim 11, wherein the first magnetic core cover is symmetrical to the second magnetic core cover, wherein the first magnetic core cover comprises a first primary magnetic core cover and a first auxiliary magnetic core cover, wherein the second magnetic core cover comprises a second primary magnetic core cover and a second auxiliary magnetic core cover, wherein the first auxiliary magnetic core cover comprises a first area based on a top view obtained by viewing the planar transformer in a direction from the first magnetic core cover to the second magnetic core cover, wherein the first primary magnetic core cover comprises a second area based on the top view, and wherein the first area is less than the second area, and
wherein the n first magnetic core pillars and the k second magnetic core pillars being disposed between the first magnetic core cover and the second magnetic core cover comprises:
the n first magnetic core pillars being disposed between the first primary magnetic core cover and the second primary magnetic core cover and being perpendicularly connected to the first primary magnetic core cover and the second primary magnetic core cover; and
the k second magnetic core pillars being disposed between the first auxiliary magnetic core cover and the second auxiliary magnetic core cover and being perpendicularly connected to the first auxiliary magnetic core cover and the second auxiliary magnetic core cover.

13. The printed circuit board of claim 11, wherein a first cross-sectional area of one of the k second magnetic core pillars is less than a second cross-sectional area of one of the n first magnetic core pillars.

14. The printed circuit board of claim 11, wherein a first cross-sectional area ratio of one of then first magnetic core pillars to one of the k second magnetic core pillars is equal to a second ratio of a quantity of turns of an auxiliary inductor winding of one of the k second magnetic core pillars to a quantity of turns of a primary-side winding of one of the n first magnetic core pillars.

15. The printed circuit board of claim 11, wherein a quantity of turns of the k auxiliary inductor windings is greater than a quantity of turns of the n primary-side windings.

16. An electronic device comprising:
a planar transformer comprising:
a magnetic core comprising:
a first magnetic core cover;
a second magnetic core cover;
n first magnetic core pillars perpendicularly disposed between the first magnetic core cover and the second magnetic core cover, wherein n is an integer greater than 0; and
k second magnetic core pillars perpendicularly disposed between the first magnetic core cover and the second magnetic core cover, wherein k is an integer greater than 0;
n primary-side windings respectively disposed on the n first magnetic core pillars and configured to generate a second magnetic flux when the n primary-side windings receive power;
n secondary-side windings respectively disposed on the n first magnetic core pillars and respectively coupled to the n primary-side windings; and
k auxiliary inductor windings respectively disposed on the k second magnetic core pillars and configured to generate a first magnetic flux when the k auxiliary inductor windings receive power,
wherein when the planar transformer receives power the first magnetic flux cancels a part of the second magnetic flux when the first magnetic flux passes through the first magnetic core cover and the second magnetic core cover.

17. The electronic device of claim 16, wherein the first magnetic core cover is symmetrical to the second magnetic core cover, wherein the first magnetic core cover comprises a first primary magnetic core cover and a first auxiliary magnetic core cover, wherein the second magnetic core cover comprises a second primary magnetic core cover and a second auxiliary magnetic core cover, wherein the first auxiliary magnetic core cover comprises a first area based on a top view obtained by viewing the planar transformer in a direction from the first magnetic core cover to the second magnetic core cover, wherein the first primary magnetic core cover comprises a second area based on the top view, and wherein the first area is less than the second area, and
wherein the n first magnetic core pillars and the k second magnetic core pillars ae being disposed between the first magnetic core cover and the second magnetic core cover comprises:
the n first magnetic core pillars being disposed between the first primary magnetic core cover and the second primary magnetic core cover and being perpendicularly connected to the first primary magnetic core cover and the second primary magnetic core cover; and
the k second magnetic core pillars being disposed between the first auxiliary magnetic core cover and the second auxiliary magnetic core cover and being perpendicularly connected to the first auxiliary magnetic core cover and the second auxiliary magnetic core cover.

18. The electronic device of claim 16, wherein a first cross-sectional area of one of the k second magnetic core pillars is less than a second cross-sectional area of one of the n first magnetic core pillars.

19. The electronic device of claim 16, wherein a first cross-sectional area ratio of one of the n first magnetic core pillars to one of the k second magnetic core pillars is equal to a second ratio of a quantity of turns of an auxiliary inductor winding of one of the k second magnetic core pillars to a quantity of turns of a primary-side winding of one of the n first magnetic core pillars.

20. The electronic device of a claim 16, wherein a quantity of turns of the k auxiliary inductor windings is greater than a quantity of turns of the n primary-side windings.
